(19) United States
(12) Patent Application Publication
(10) Pub. No.: US 2002/0078789 A1
(43) Pub. Date: Jun. 27, 2002

(54) Brake lever having detachable hand grip

(76) Inventor: Zen Ming Chen, Chang Hua Hsien (TW)

Correspondence Address: Zen Ming CHEN, P.O. Box 63-99, Taichung, 406, TW

(21) Appl. No.: 09/746,663

(22) Filed: Dec. 21, 2000

(51) Int. Cl. B62K 23/06

(52) U.S. Cl. 74/551.8; 74/502.2; 74/489

(57) ABSTRACT

A brake lever for cycles includes a handle, and a hand grip detachably secured onto the handle with one or more fasteners for allowing the hand grip to be disengaged from the handle and to be replaced or changed with the other hand grips and for changing a new or decorative hand grip. The hand grip has a cover for facilitating the holding or grasping of the users. The hand grip is preferably U-shaped and has a ridge extended from a curved middle portion to form a peripheral shoulder between the handle and the ridge for solidly engaging with the hand grip.

### BACKGROUND OF THE INVENTION

1. Field of the Invention

The present invention relates to a brake lever, and more particularly to a brake lever for cycles having a hand grip detachable from the handle of the brake lever for changing with the other hand grips.

2. Description of the Prior Art

The applicant has developed various kinds of typical brake levers for cycles. U.S. Pat. No. 5,910,193 to Chen discloses one of the typical brake lever assemblies including a crank having a beam pivotally coupled to a seat or a base and having a handle for being grasped by the cycle riders. The crank, particularly the handle of the crank is made of cast iron or the like and may not be suitably or solidly held or grasped by the cycle riders during the wet days or the raining days.

U.S. Pat. No. 5,584,210 to Gelbein discloses the other typical brake lever having a soft cover engaged around the handle of the brake lever. However, the cover is simply engaged onto the handle and may be easily disengaged from the handle. Mostly, the cover may be rotated relative to the handle and thus may not be suitably or solidly held or grasped by the cycle riders during the wet days or the raining days.

The present invention has arisen to mitigate and/or obviate the afore-described disadvantages of the conventional brake levers.

### SUMMARY OF THE INVENTION

The primary objective of the present invention is to provide a brake lever for cycles including a hand grip detachable from the handle of the brake lever for changing with the other hand grips.

In accordance with one aspect of the invention, there is provided a brake lever for cycles comprising a handle, a hand grip, and means for securing the hand grip to the handle.

The hand grip includes a hand grip body, and a cover secured onto the hand grip body, the securing means is used for securing the hand grip body to the handle.

The hand grip body includes a pair of panels dependent therefrom for defining a U-shaped configuration. The securing means includes at least one fastener engaged through the handle and engaged with the hand grip body.

The hand grip is preferably U-shaped for engaging onto the handle. The handle includes a ridge extended therefrom for defining a peripheral shoulder between the handle and the ridge, the hand grip is engaged with the peripheral shoulder of the handle.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a brake lever in accordance with the present invention;

FIG. 2 is a cross sectional view taken along lines 2-2 of FIG. 1;

FIG. 3 is a perspective view of the brake lever; and

FIG. 4 is a cross sectional view taken along lines 4-4 of FIG. 3.

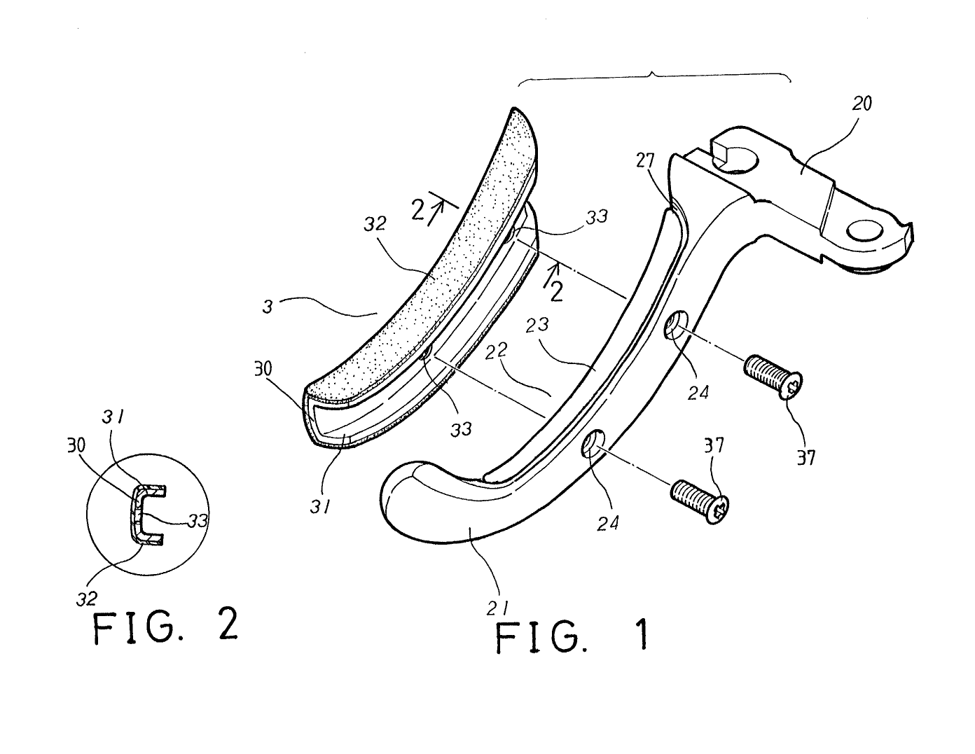

### DETAILED DESCRIPTION OF THE PREFERRED EMBODIMENT

Referring to the drawings, a brake lever in accordance with the present invention comprises a beam 20 for pivotally securing to the seat or the base of the brake lever, which is not related to the present invention and will not be described in further details. The brake lever includes a handle 21 extended from the beam 20 and substantially perpendicular to or inclined relative to the beam 20 for forming the typical crank for the cycles. The handle 21 includes a curved middle portion 22 formed therein and includes a ridge 23 extended from the curved middle portion 22 and having a peripheral width smaller than that of the handle 21, best shown in FIG. 4, for forming or defining a peripheral shoulder 27 between the handle 21 and the ridge 23 or around the ridge 23. The handle 21 includes one or more holes 24 formed therein and formed through the ridge 23 for receiving fasteners 37 therein.

One or more hand grips 3 each includes a substantially U-shaped cross section having a pair of panels 31 dependent from a hand grip body 30, and having a soft or resilient cover 32 secured onto the hand grip body 30 with such as the adhesive materials, or by welding process or the like. The cover 32 is preferably made of rubber, plastic or the other soft or resilient materials that may be suitably or solidly held or grasped by the users. The hand grip body 30 is preferably made of harder materials, such as fiber-reinforced plastic materials, metal materials, etc., and includes one or more screw holes 33 formed therein for threading with the fasteners 37 which may detachably secure the hand grip 3 to the handle 21 of the brake lever.

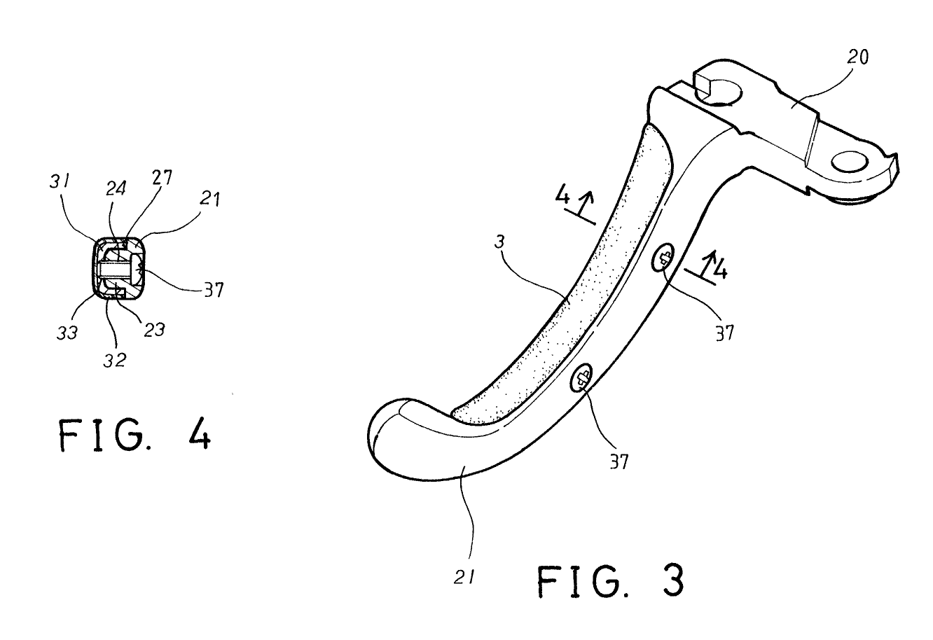

In operation, as shown in FIGS. 3 and 4, the hand grip 3 may be detached from the handle 21 by unthreading the fasteners 37 relative to the handle 21, and the other hand grips 3 may be secured onto the handle 21 with the fasteners 37. The hand grips 3 may include different colors or patterns provided thereon and may be changed with each other for decorative purposes. The hand grips 3 may also be replaced or changed with the other ones when they are damaged or when the cover 32 has been worn out.

The changeable hand grips 3 greatly benefits the cycle riders. For example, some of the hand grips 3 may be particularly designed for use in the raining days and may be secured onto the handle 21 during the raining days. The other hand grips 3 may be designed to absorb the sweat of the cycle riders who may easily sweat their their hands while holding the hand grips. The further hand grips 3 may include decorative colors or patterns thereon for decorative purposes.

Accordingly, the brake lever for cycles in accordance with the present invention includes a hand grip that may be detached from the handle of the brake lever for changing with the other hand grips.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A brake lever for cycles comprising:
a handle,
a hand grip, and
means for securing said hand grip to said handle.

2. The brake lever according to claim 1, wherein said hand grip includes a hand grip body, and a cover secured onto said hand grip body, said securing means secures said hand grip body to said handle.

3. The brake lever according to claim 2, wherein said hand grip body includes a pair of panels dependent therefrom for defining a U-shaped configuration.

4. The brake lever according to claim 2, wherein said securing means includes at least one fastener engaged through said handle and engaged with said hand grip body.

5. The brake lever according to claim 1, wherein said hand grip is U-shaped and engaged on said handle.

6. The brake lever according to claim 1, wherein said handle includes a ridge extended therefrom for defining a peripheral shoulder between said handle and said ridge, said hand grip is engaged with said peripheral shoulder of said handle.

7. The brake lever according to claim 1, wherein said securing means includes at least one fastener engaged through said handle and engaged with said hand grip.
